(19) United States
(12) Patent Application Publication
(10) Pub. No.: US 2025/0378984 A1
(43) Pub. Date: Dec. 11, 2025

(54) Magnetic Integrated Inductor and Assembly Thereof

(71) Applicant: MAGSONDER INNOVATION (JIANGSU) CO., LTD., Suzhou City (CN)

(72) Inventors: Zhi HUANG, Suzhou City (CN); Jiang CHU, Suzhou City (CN); Bozhi FAN, Suzhou City (CN); Yunfeng WANG, Suzhou City (CN)

(21) Appl. No.: 19/223,211

(22) Filed: May 30, 2025

(30) Foreign Application Priority Data
Jun. 5, 2024 (CN) 2024107193047
Jun. 5, 2024 (CN) 2024212672460

(51) Int. Cl. H01F 27/255; H01F 27/02; H01F 27/30

(52) U.S. Cl. CPC H01F 27/255; H01F 27/306; H01F 27/02

(57) ABSTRACT

A magnetic integrated inductor and an assembly thereof. The magnetic integrated inductor includes center pillar cores, coils, a yoke core and a spacer core, where the number of the center pillar cores is at least two; the coils are wound on the center pillar cores, and two ends of the center pillar core are respectively in contact connection with the yoke core; the spacer core is arranged between two adjacent center pillar cores and is isolated from the coils on the two adjacent center pillar cores, a side of the spacer core is held in contact by a bottom face of an adjacent yoke core; and the inductor assembly includes the magnetic integrated inductor and the housing, the housing having a receiving space into which the magnetic integrated inductor is placed through an opening of the housing.

### TECHNICAL FIELD

The present application relates to a magnetic integrated inductor and an assembly thereof, and more particularly, to a magnetic integrated inductor and an assembly thereof prepared using a magnetic powder core material.

### BACKGROUND ART

An inductor is used in electronic devices for filtering purposes, capable of filtering electromagnetic interference signals and suppressing electromagnetic wave radiation emitted from high-speed signal lines. A magnetic integrated inductor can integrate two or more discrete inductors through shared magnetic paths, thereby reducing volume and cost, decreasing core losses, and improving power efficiency. Magnetic integrated inductors are widely used in photovoltaic inverters, including: maximum power point tracking (MPPT) circuits, passive LC filter networks for three-phase AC inverter output, and boost circuits in high-power uninterruptible power supplies or rectifier power modules.

In these applications, the non-shared magnetic paths of the magnetic integrated inductor typically employ metal magnetic powder core materials, while the shared magnetic paths generally use high-magnetic permeability magnetic materials, such that the magnetic coupling between individual inductors is minimal and does not affect independent control of the inductors. High-magnetic permeability magnetic materials generally include laminated materials such as amorphous ribbons or ferrite materials. In industrial applications, laminated materials like amorphous ribbons often encounter high-frequency noise issues due to their relatively large magnetostriction coefficients; when ferrite materials are used for shared magnetic paths, their relatively low saturation flux density often causes premature saturation upon contact with non-shared magnetic paths such as metal magnetic powder core materials, resulting in sudden inductance drop, with inferior inductance performance under DC current compared to amorphous materials, as shown in FIG. 1, which in practical applications leads to increased ripple and control difficulties.

### SUMMARY OF THE INVENTION

In order to solve the problems of noise and saturation, the present application provides a magnetic integrated inductor and an assembly thereof, and the technical solution of the present application is as follows: including a center pillar core, a coil, a yoke core and a spacer core, where the number of the center pillar cores is at least two, and the center pillar cores are arranged in parallel; the coil is wound on the center pillar core, and two ends of the center pillar core are respectively in contact connection with the yoke core; the spacer core is arranged between two adjacent center pillar cores and is isolated from the coils on the two adjacent center pillar cores, a side of the spacer core is held in contact by a bottom face of an adjacent yoke core, and the side of the spacer core and the bottom face of the yoke core are parallel to an axis of the center pillar core; the center pillar core, the yoke core and the spacer core are all made of metal magnetic powder cores.

The cross-sectional area of the spacer core is not less than 1.5 times that of the yoke core. The magnetic permeability of the spacer core is not less than 1.5 times that of the yoke core. The magnetic integrated inductor further includes two side pillar cores arranged in parallel with the spacer core, and the sides of the two side pillar cores are closely adhered to the bottom face of the outermost yoke core.

The present application also provides an inductor assembly including the magnetic integrated inductor and the housing, the housing having a receiving space into which the magnetic integrated inductor is placed through an opening of the housing.

The beneficial effects of the present application are as follows: by adopting the all-metal-magnetic-powder-core solution, compared to laminated amorphous materials or silicon steel materials, the magnetostriction coefficient of the material is significantly smaller; the metal magnetic powder core exhibits soft saturation characteristics and, compared to ferrite materials, eliminates the saturation risk of sudden inductance drop. This magnetic integrated inductor solution can maintain a relatively small coupling coefficient K between adjacent coils while reducing core material usage, which helps to lower costs and improve efficiency.

### BRIEF DESCRIPTION OF THE DRAWINGS

FIG. 1 shows a diagram of a relationship between inductance of different common magnetic path materials and DC current;

FIG. 2 shows a three-phase magnetic integrated inductor;

FIG. 3 shows a relationship between a coupling coefficient and a magneto-resistance ratio;

FIG. 4 shows a two-phase magnetic integrated inductor;

FIG. 5 shows a recessed three-phase magnetic integrated inductor; and

FIG. 6 shows a three-phase magnetic integrated inductor assembly.

In the drawings:
11—center pillar core
12—coil
13—yoke core
131—bottom face of yoke core
14—spacer core
141—side of spacer core
15—side pillar core
16—recess
17—housing
171—internal boss of housing
R1—magnetic resistance formed by magnetic flux passing through a center pillar core 11 and a spacer core 14
R2—magnetic resistance formed by magnetic flux passing through a yoke core 13
Ae1—cross-sectional area of yoke core
Ae2—cross-sectional area of spacer core
Ac—contact surface of spacer core and yoke core
AX—center pillar core axis

### DETAILED DESCRIPTION OF THE INVENTION

### Embodiment 1

The technical solution of the present application is specifically described by taking two-phase and three-phase magnetic integrated inductors as an example.

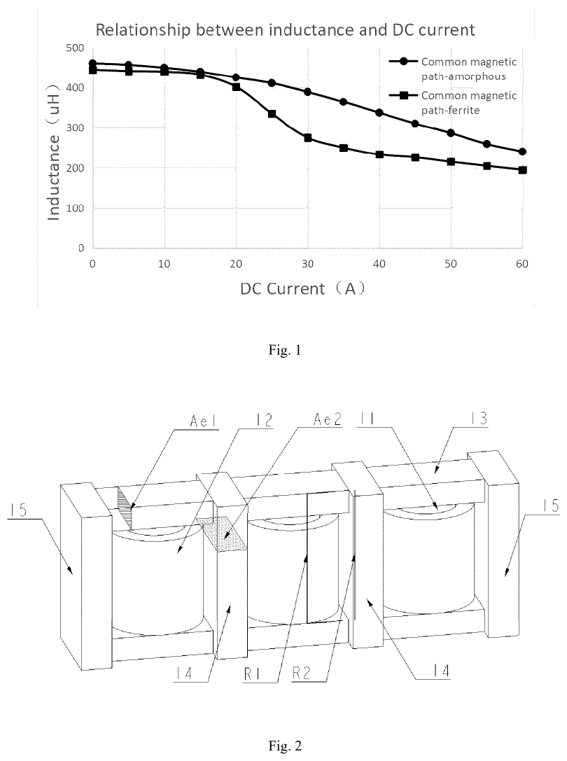

As shown in FIG. 2, a three-phase magnetic integrated inductor provided by the present application includes center pillar cores 11, coils 12, a yoke core 13 and a spacer core 14, three center pillar cores 11 are arranged in parallel; three coils 12 are wound on the center pillar cores 11, and two ends of the center pillar core 11 are respectively in contact connection with the yoke core 13; the spacer core 14 is arranged between two adjacent center pillar cores 11 and is isolated from coils 12 on the two adjacent center pillar cores 11, a side 141 of the spacer core is held in contact by a bottom face 131 of an adjacent yoke core, and the side 141 of the spacer core and the bottom face 131 of the yoke core are parallel to an axis of the center pillar core; the center pillar core 11, the yoke core 13 and the spacer core 14 are all made of metal magnetic powder cores. Two side pillar cores 15 arranged in parallel with the spacer core 14, and the sides of the two side pillar cores 15 are closely adhered to the bottom face of the outermost yoke core 13 of the inductor.

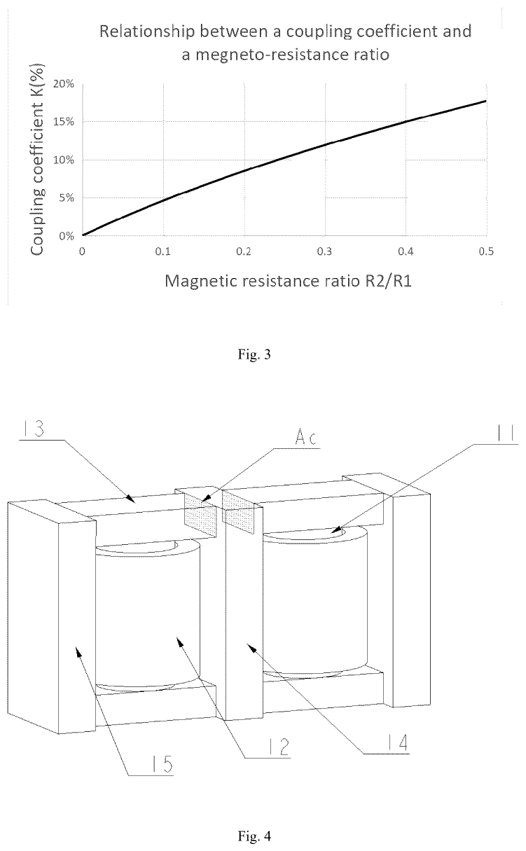

As shown in FIG. 2, the magnetic flux passing through the center pillar core 11 and the spacer core 14 forms the reluctance R1, and the magnetic flux passing through the yoke core 13 forms the reluctance R2, with Ae1 being the cross-sectional area of the yoke core 13 and Ae2 being the cross-sectional area of the spacer core 14. The coupling coefficient K between the adjacent coils 12 is related to the reluctance ratio R2/R1, and as shown in FIG. 3, if the coupling coefficient K should reach 10% or less in order to reduce mutual interference, the reluctance ratio R2/R1 should be 0.24 or less, i.e., the reluctance R2 formed by the magnetic flux passing through the yoke core 13 should be minimized. With the magnetic resistance formula, a magnetic path length le is reduced, the magnetic permeability u and the magnetic flux cross-section Ae are increased, and a smaller magnetic resistance R can be obtained to achieve the decoupling function. A fundamental condition is that the magnetic permeability of the magnetic powder core itself is relatively low and cannot reach thousands as much as ferrite or amorphous materials, so a larger magnetic flux cross-section Ae is necessary to achieve the decoupling function. In the case where the magnetic path length le decreases by at most about ½ and the magnetic permeability u increases by 1.5 times with respect to R1, the cross-sectional area Ae2 of the spacer core 14 becomes at least 1.5 times larger than the cross-sectional area Ae1 of the yoke core 13 for the magnetic flux passing through the yoke core 13 to form the magnetic resistance R2, so that the magnetic resistance ratio R2/R1 can be reduced to 0.24 or less.

In one implementation, the saturation magnetic flux density Bs of the spacer core 14 is less than that of the yoke core 13. If a high Bs magnetic powder core is used in combination with a high Bs magnetic powder core, or a low Bs magnetic powder core is used in combination with a low Bs magnetic powder core, there is no design significance because the flux cross-sections are approximately similar when Bs are similar, which makes it difficult to achieve a reduction of the reluctance ratio R2/R1 below 0.24 for providing a magnetic flux circuit that decouples the multi-phase inductance. Therefore, the saturation magnetic flux density Bs of the spacer core is smaller than that of the yoke core, so that the cross-sectional area Ae2 of the spacer core 14 is larger than the cross-sectional area Ae1 of the yoke core 13 without material waste, and the reluctance ratio R2/R1 can be reduced to 0.24 or less to achieve the function of reducing the coupling coefficient K.

It is particularly emphasized that the sides 141 of the spacer core must be held in contact by the bottom face 131 of the adjacent yoke core, as shown in FIG. 4 for a two-phase magnetic integrated inductor, Ac being the contact surface of the spacer core 14 with the yoke core 13. In a practical design, it must be taken into account that the coupling coefficient K may vary depending on the load conditions of the inductor. In the case where the coil load current gradually increases, since the saturation flux density Bs of the yoke core 13 is greater than that of the spacer core 14, the contact surface Ac of the spacer core 14 will be saturated earlier, and it can be seen from FIG. 4 that the saturation of the contact surface Ac of the spacer core 14 will lead to a decrease in the magnetic permeability and an increase in the magnetic resistance of this region, and will further hinder the magnetic flux from entering into the adjacent winding, thereby reducing the coupling coefficient K between the adjacent windings.

On the contrary, it is not good for the spacer core 14 to be compressed by the upper and lower yoke cores 13, so that when the contact surface is saturated in advance, it is more difficult for the magnetic flux to move away from the spacer core magnetic path and to enter the adjacent winding more easily, resulting in an increase in the coupling coefficient K.

In one implementation, the spacer core 14 is made of a Fe—Si—Al magnetic powder core, which is more suitable for use as a spacer core because of its high magnetic permeability, low saturation magnetic flux density, and high-cost performance.

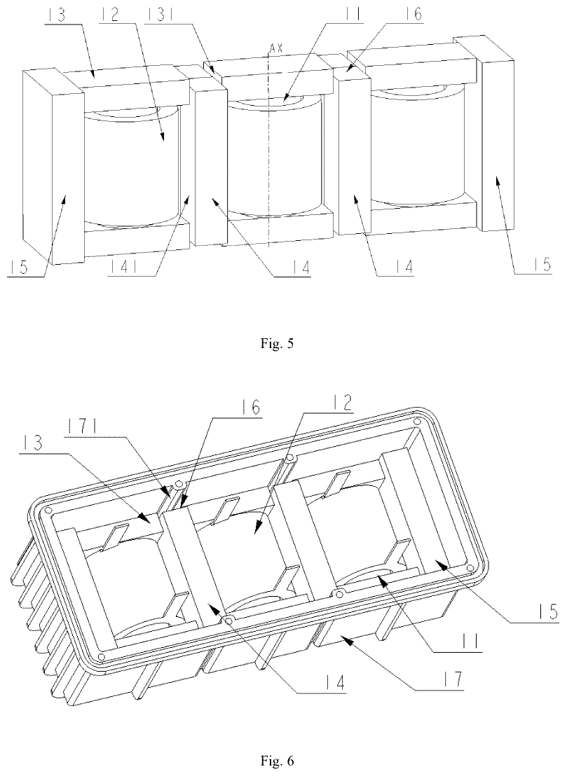

Alternatively, the spacer core 14 is composed of a plurality of cores arranged side by side in the parallel magnetic path direction. As shown in FIG. 5, each of the spacer cores 14 is composed of two cores arranged side by side in the parallel magnetic path direction, which helps to reduce the volume of the spacer core formed at one time and improve the magnetic permeability of the spacer core. On the contrary, if multiple cores are arranged side by side in the perpendicular magnetic path direction, the assembled air gap will lead to the decrease of the overall magnetic permeability of the spacer core, which is not conducive to the reduction of the coupling coefficient K between two adjacent windings.

In one implementation, the materials of the center pillar core 11 and the yoke core 13 are the same, and both are metal magnetic powder cores with a magnetic permeability of not greater than 60. In one implementation, the spacer core 14 and the side pillar core 15 are made of the same material, and both are metal magnetic powder cores with a magnetic permeability of not less than 90.

In one implementation, after the sides of the spacer core 14 are held in contact by the bottom face of the adjacent yoke core 13, the ends of the spacer core 14 are formed with recesses 16. As shown in FIG. 5, the length of the spacer core 14 is slightly shorter, and the recess 16 is formed in the end face to facilitate a good fit with the internal boss 171 of the housing 17 during assembly (as shown in FIG. 6).

In practice, the magnetic flux generated by adjacent coils has the effect of canceling as much as possible on the spacer core 14, and can be appropriately adjusted according to the application not to be used; for applications such as multi-path MPPT circuit of a photovoltaic inverter or double boost circuit of a communication power supply, the magnetic flux directions of adjacent center pillar cores 11 need to be opposite, and in a three-phase inverter inductor of an energy storage inverter, the magnetic flux directions of adjacent center pillar cores 11 can be made the same, and the magnetic flux generated by adjacent coils can be canceled on the spacer core 14. The shape of the yoke core 13 may be racetrack shaped, and the curvature of the sides of the spacer core 14 matches the racetrack shape, which makes it easier to follow the shape of the circular coil, reducing the volume of the magnetic integrated inductor. The above can be adjusted accordingly according to needs.

### Embodiment 2

The present application also provides an inductor assembly including a magnetic integrated inductor and a housing 17 described above. The housing 17 has a receiving space into which the above-mentioned magnetic integrated inductor is placed through the opening of the housing 17. As shown in FIG. 6, the center pillar core 11 and the upper and lower yoke cores 13 are made of a Fe—Si alloy powder core with a magnetic permeability of 60, and three coils 12 are wound around the center pillar core 11; the spacer core 14 is an Fe—Si—Al alloy powder core, and the magnetic permeability is 125; the sides of the spacer core 14 are held in contact by the bottom faces of the adjacent yoke cores 13. For better three-phase balance, the side pillar core 15, like the spacer core 14, uses a Fe—Si—Al alloy powder core with a magnetic permeability of 125. The magnetic integrated inductor exhibits a calculated maximum flux density of 1.0 T in the center pillar core at the maximum current of 55 A, and it can be seen by looking up the material property table that the magnetic permeability of the Fe—Si alloy powder core is about 21. When the magnetic flux cross section Ae of the spacer core is twice the magnetic flux cross section of the yoke core, the maximum magnetic flux density of the spacer core is 0.5 T at the maximum current of 55 A, and it can be seen by looking up the material property table that the magnetic permeability of the Fe—Si—Al alloy powder core is about 56, and the coupling coefficient can be controlled to be less than 5%. The length of the spacer core 14 is slightly shorter, and a recess 16 is formed on the end face to facilitate assembly with the housing 17 to form a good fit with an internal boss 171 of the housing, and a threaded hole is provided on the boss 171 to facilitate a locking connection between the inductor assembly and the mechanism.

### Embodiment 3

The present application also provides a magnetic integrated inductor including:
a plurality of center pillar cores (11) and coils (12) wound around the center pillar cores (11);
yoke cores (13) with a number of twice as many as the center pillar cores (11), two ends of each of the center pillar cores (11) respectively abutting one of the yoke cores (13); and
at least one spacer core (14), one spacer core (14) being arranged between every two center pillar cores (11), and the spacer core (14) being isolated from the coils on the two adjacent center pillar cores (11);
wherein each of the center pillar cores (11) is arranged parallel to each other, a side (141) of the spacer core is configured to be held in contact by a bottom face (131) of an adjacent yoke core, and the side (141) of the spacer core and the bottom face (131) of the yoke core are parallel to an axis of the center pillar core; the center pillar core (11), the yoke core (13) and the spacer core (14) are all made of metal magnetic powder cores.

The magnetic flux passing through the center pillar core 11 and the spacer core 14 forms the reluctance R1, and the magnetic flux passing through the yoke core 13 forms the reluctance R2, with Ae1 being the cross-sectional area of the yoke core 13 and Ae2 being the cross-sectional area of the spacer core 14. The coupling coefficient K between the adjacent coils 12 is related to the reluctance ratio R2/R1, and as shown in FIG. 3, if the coupling coefficient K should reach 10% or less in order to reduce mutual interference, the reluctance ratio R2/R1 should be 0.24 or less, i.e., the reluctance R2 formed by the magnetic flux passing through the yoke core 13 should be minimized. With the magnetic resistance formula, a magnetic path length le is reduced, the magnetic permeability u and the magnetic flux cross-section Ae are increased, and a smaller magnetic resistance R can be obtained to achieve the decoupling function. A fundamental condition is that the magnetic permeability of the magnetic powder core itself is relatively low and cannot reach thousands as much as ferrite or amorphous materials, so a larger magnetic flux cross-section Ae is necessary to achieve the decoupling function. In the case where the magnetic path length le decreases by at most about ½ and the magnetic permeability u increases by 1.5 times with respect to R1, the cross-sectional area Ae2 of the spacer core 14 becomes at least 1.5 times larger than the cross-sectional area Ae1 of the yoke core 13 for the magnetic flux passing through the yoke core 13 to form the magnetic resistance R2, so that the magnetic resistance ratio R2/R1 can be reduced to 0.24 or less.

The specific embodiments described above are merely exemplary and are intended to facilitate understanding of this patent by a person skilled in the art, which should not be construed as limiting the scope of this patent. Any modifications or variations made based on the technical solutions disclosed in this patent that are substantially identical or equivalent in technical content shall fall within the scope of this patent.

1. A magnetic integrated inductor, comprising center pillar cores, coils, a yoke core and a spacer core, wherein the number of the center pillar cores is at least two, and the center pillar cores are arranged in parallel; the coils are wound on the center pillar cores, and two ends of the center pillar core are respectively in contact connection with the yoke core; the spacer core is arranged between two adjacent center pillar cores and is isolated from the coils on the two adjacent center pillar cores, a side of the spacer core is held in contact by a bottom face of an adjacent yoke core, and the side of the spacer core and the bottom face of the yoke core are parallel to an axis of the center pillar core; the center pillar core, the yoke core and the spacer core are all made of metal magnetic powder cores,
wherein cross-sectional area of the spacer core is not less than 1.5 times that of the yoke core.

2. The magnetic integrated inductor according to claim 1, further comprising two side pillar cores arranged in parallel with the spacer core, and the sides of the side pillar cores are closely adhered to the bottom face of the outermost yoke core of the inductor.

3. The magnetic integrated inductor according to claim 1, wherein magnetic permeability of the spacer core is not less than 1.5 times that of the yoke core.

4. The magnetic integrated inductor according to claim 1, wherein a saturation magnetic flux density of the spacer core is less than that of the yoke core.

5. The magnetic integrated inductor according to claim 1, wherein the material of the spacer core is a Fe—Si—Al magnetic powder core.

6. The magnetic integrated inductor according to claim 1, wherein the spacer core is composed of a plurality of cores arranged side by side in the magnetic path direction.

7. The magnetic integrated inductor according to claim 1, wherein the materials of the center pillar core and the yoke core are the same, and both are metal magnetic powder cores with a magnetic permeability of not greater than 60.

8. The magnetic integrated inductor according to claim 1, wherein after the sides of the spacer core are held in contact by the bottom face of the adjacent yoke core, the ends of the spacer core are formed with recesses.

9. The magnetic integrated inductor according to claim 2, wherein the spacer core and the side pillar core are made of the same material, and both are metal magnetic powder cores with a magnetic permeability of not less than 90.

10. A magnetic integrated inductor, comprising:
a plurality of center pillar cores and coils wound around the center pillar cores;
yoke cores with a number of twice as many as the center pillar cores, two ends of each of the center pillar cores respectively abutting one of the yoke cores; and
at least one spacer core, one spacer core being arranged between every two center pillar cores, and the spacer core being isolated from the coils on the two adjacent center pillar cores;
wherein each of the center pillar cores is arranged parallel to each other, a side of the spacer core is configured to be held in contact by a bottom face of an adjacent yoke core, and the side of the spacer core and the bottom face of the yoke core are parallel to an axis of the center pillar core; the center pillar core, the yoke core and the spacer core are all made of metal magnetic powder cores,
wherein cross-sectional area of the spacer core is not less than 1.5 times that of the yoke core;
or magnetic permeability of the spacer core is not less than 1.5 times that of the yoke core.

11. The magnetic integrated inductor according to claim 10, further comprising two side pillar cores arranged in parallel with the spacer core, and the sides of the two side pillar cores are closely adhered to the bottom face of the outermost yoke core.

12. The magnetic integrated inductor according to claim 10, wherein a saturation magnetic flux density of the spacer core is less than that of the yoke core.

13. The magnetic integrated inductor according to claim 10, wherein the material of the spacer core is a Fe—Si—Al magnetic powder core.

14. The magnetic integrated inductor according to claim 10, wherein the spacer core is composed of a plurality of cores arranged side by side in the magnetic path direction.

15. The magnetic integrated inductor according to claim 10, wherein the materials of the center pillar core and the yoke core are the same, and both are metal magnetic powder cores with a magnetic permeability of not greater than 60.

16. The magnetic integrated inductor according to claim 11, wherein the spacer core and the side pillar core are made of the same material, and both are metal magnetic powder cores with a magnetic permeability of not less than 90.

17. An inductor assembly, comprising the magnetic integrated inductor according to claim 1 and a housing, the housing having a receiving space into which the magnetic integrated inductor is placed through an opening of the housing.

18. The inductor assembly according to claim 17, wherein a boss is provided in the housing to be fitted corresponding to the recess.

19. An inductor assembly, comprising the magnetic integrated inductor according to claim 10 and a housing, the housing having a receiving space into which the magnetic integrated inductor is placed through an opening of the housing.

20. The inductor assembly according to claim 19, wherein a boss is provided in the housing to be fitted corresponding to the recess.
